(19) United States
(12) Patent Application Publication
(10) Pub. No.: US 2020/0033911 A1
(43) Pub. Date: Jan. 30, 2020

(54) LAPTOP COMPUTER WITH MULTIPLE DISPLAYS

(71) Applicant: George MOSER, Santa Clara, CA (US)

(72) Inventor: George MOSER, Santa Clara, CA (US)

(21) Appl. No.: 16/113,710

(22) Filed: Aug. 27, 2018

Related U.S. Application Data
(60) Provisional application No. 62/764,305, filed on Jul. 27, 2018.

(51) Int. Cl. G06F 1/16

(52) U.S. Cl. CPC G06F 1/162; G06F 1/1649; G06F 1/1681; G06F 3/04886; G06F 1/1662; G06F 1/1679; G06F 1/1643

(57) ABSTRACT

A portable computer is provided having a first display panel rotatable with respect to the computer base to adjust the viewing angle of the first display; a second display panel embedded in the computer base in a fixed, non-adjustable position; and a support structure attached to the computer that allows the user to adjust the viewing angle of the second screen for better viewing quality. A reduced depth keyboard may be implemented to allow a large second screen on the computer base.

### FIELD OF THE INVENTION

The present invention relates in general to the computer field, and in particular, to portable computers.

### BACKGROUND OF THE INVENTION

Laptop computers have risen in popularity throughout the world and have become a major component of modern life, both in the business and personal areas. Smart phones have taken over some traditional uses of computers, such as emails and social communications, but for more demanding applications the laptop computer remains the most important tool for business and personal use.

The computing power of computers keeps growing, but there is an area where further improvement is needed. Typical laptops have only one display, which may be a serious limitation in many use cases. A second display would greatly improve productivity by allowing users to more easily view two open files at the same time, compare and transfer information between files, work on one task while running a second task on a second screen, check emails on one screen while working on an open document on another screen, and many other dual screen applications. The computing power and the necessary software are already available for such tasks, but optimal hardware infrastructure (multiple screens) is lacking.

FIG. 1 shows a typical prior art laptop computer 10, which provides a single display screen 11, held in place between panel 16 in the back of the display (customarily referred to as panel A in the computer industry) and front panel 17 (panel B). The keyboard 12 and the touchpad 13 are located on the surface of panel 15, which is customarily referred to as panel C in the computer industry. The bottom cover 14 of the computer is located under panel C and is customarily referred to as panel D in the computer industry. The computer motherboard, the battery and other internal devices are located between panels C and D. Panels C and D and all the electronic components and devices housed between them are referred to collectively as the base unit of the laptop. Panels A and B, along with the LCD panel 11 positioned between them, together constitute the display unit of the laptop.

As shown in FIG. 1, state of the art laptop computers are equipped with only one screen 11, lacking a second screen which would enable the user to optimally perform multiple tasks at the same time.

FIG. 2 shows laptop computer 20, having a dual-display design described in U.S. Pat. No. 9,501,097, issued on Nov. 22, 2016 (“the '097 patent”), to the same inventor of the present application. Laptop computer 20 features a second screen 22 hinged on the laptop base unit in order to allow the user to adjust the viewing angle of the second screen 22 (in addition to adjusting the viewing angle of the main screen 21, which has its own separate hinges 25 and 26). The hinges of the second screen 22 are not visible in FIG. 2 because they are located inside the computer base unit 23 (i.e. under panel C). The '097 patent design provides multiscreen functionality and viewing angle adjustability for both screens. The adjustability of the second screen is very important because a totally horizontal, non-adjustable position of the screen would not provide optimal image quality for the user. Horizontal fixed displays also have the problem that they reflect the ubiquitous overhead lighting of the room or work area, further deteriorating image quality. By rotating the second screen about its internal hinges, an optimal viewing angle can be achieved. The '097 patent does provide dual screen adjustability and optimal image quality on both screens, but it also has complexity and cost issues associated with it, because attaching a hinged display to the base unit is very challenging. The base 23 is usually fully packed with electronic components, battery and devices, so it is difficult to find the space to house and hinge the second screen without unduly increasing the total thickness of the laptop. The increased complexity also increases the cost of this solution, which may be ideal for many high end power users, but in many cases not within the budget of an average consumer.

Apple Computer has released models of Macbook Pro laptop computers having a secondary display within the base unit, referred to as a Touch Bar. The Touch Bar is fixed in a “flat” orientation relative to a surface on which the computer rests, impairing viewing quality. While perhaps sufficient for a small display used for collateral functions, such a configuration may be undesirable for a relatively larger second display used to extend or mirror an operating system desktop.

Therefore, a need remains in the computer industry for a simple, cost-effective, low-weight and thin laptop computer that will provide multiple screen capabilities and viewing angle adjustability for both screens for optimal image quality on both screens, making this very vital functionality and capability available more broadly.

### SUMMARY

In accordance with one aspect of the embodiments, a laptop computer system is provided having a display unit hinged to a base unit in a clamshell configuration. The display unit may be attached to the base unit along a first edge via a first display unit hinge structure, whereby a front surface of the base unit and a front surface of the display unit can fold adjacent to one another. The display unit includes a first display panel. The viewing angle of the first display panel can be readily adjusted by a user via movement of the first hinge structure. The computer also includes a second display panel fixedly mounted in the laptop base, typically in a fixed, substantially parallel orientation with respect to a front surface of the base unit. A support structure can provide for adjustment of the angle of inclination of the base unit (and therefore, the second display panel) relative to a support surface on which the computer rests (and therefore also relative to a user of the computer) by tilting the base unit. The support structure may be attached to the base unit, and movable between a deployed position and a retracted position.

The adjustability of the second screen can be discrete or continuous. A very simple embodiment of the invention contemplates the use of a pivot with just two positions for the support structure: retracted or deployed. In retracted position, the support structure is inactive and stowed away, thus providing zero adjustment of the viewing angle. In deployed position, that pivot would provide a certain pre-determined fixed angle of viewing angle adjustment, which can be chosen to accommodate most users.

Such a support structure may include one or more support beams, which may be attached to a bottom side of the laptop base by one or more support structure hinges. In some embodiments, the support structure hinges may be positioned on the bottom side of the laptop base approximately two-thirds of the distance between the front edge and the rear edge of the laptop base unit, thereby enabling the support structure (when deployed) to lift the rear edge of the laptop computer base by an amount greater than the height of the deployed support structure itself. Two or more fixed feet may be attached to the bottom side of the laptop base proximate a front edge thereof.

Other embodiments may provide a range of variable, or even continuous, adjustment of the viewing angle for the second display panel. For example, continuously adjustable hinge, such as a friction hinge, may be used to rotate a support structure to any desired angle, and maintain that angle, providing the exact amount of viewing angle adjustment needed for that user. In some embodiments, a telescoping support beam may provide continuous or multiple levels of adjustment. Other embodiments include support hinges with multiple discrete adjustability, with stops or detents enabling the support structure to assume a limited number of adjustment positions, designed and pre-determined to fit the majority of users. In some embodiments, support beams may linearly extend from linear guides that are attached to or within the laptop computer base unit.

From a location point of view, in accordance with one embodiment the support structure is located underneath the D-panel, i.e. under the bottom cover of the laptop. That location though has the potential to increase the total thickness of the laptop. Another embodiment provides a small cavity under the D-panel, with the support structure mounted inside that recess and deploying out of it as needed. Yet another embodiment provides a pivot inside the computer base, with support beams deploying out through slits in the D-panel.

Other embodiments provide a support structure attached to the sides of the laptop base, which is also an attractive location, because the width of the laptop is not as big a challenge as the depth in the design of multiscreen computers. In yet another embodiment, the support structure can be attached to the rear surface of the computer base.

In some embodiments, a support structure may include a deployable foot attached or integrally formed proximate a distal end of each support beam. When a support beam is in a retracted position, e.g. flush against a bottom side of the laptop computer base unit, a portion of the deployable foot may extend below the support beam for contact with a support surface on which the laptop computer rests, thereby serving as a support foot both when the support structure is in a retracted position and a deployed position.

In a multiscreen computer it is difficult to fit a full-size keyboard and a large second screen in the C-panel. Some embodiments may overcome that issue either with a special keyboard with reduced depth or by using a full-size touchscreen as a second screen, occupying most or all of the area of the C-panel, and utilizing a virtual keyboard to accept user input, while providing a support structure as described above to incline the large touchscreen to a favorable viewing angle.

These and other aspects of the embodiments will be apparent to a person of ordinary skill in view of the disclosure herein.

### BRIEF DESCRIPTION OF THE DRAWINGS

FIG. 1 is a perspective view of a prior art portable computer.

FIG. 2 is a perspective view of a prior art portable computer with dual displays.

FIG. 3 is a perspective view of a portable computer in accordance with one embodiment.

FIG. 4A is a side elevation of the portable computer of FIG. 3, shown with retracted support structure.

FIG. 4B is an expanded partial view of the portable computer of FIG. 4A, with focus on the support structure.

FIG. 5A is a side elevation of the portable computer of FIG. 4A, shown with a deployed support structure.

FIG. 5B is an expanded partial view of the portable computer of FIG. 5A, with focus on the telescopic support structure.

FIG. 6A is a side elevation of a portable computer according to another embodiment, with the laptop feet integrated with the support structure.

FIG. 6B is an expanded partial view of the portable computer of FIG. 6A, with focus on the support structure.

FIG. 7 is a side elevation of the portable computer of FIG. 6A, shown with the support structure deployed.

FIG. 8 is a side elevation of a portable computer according to another embodiment, with the support structure recessed into a pocket of the laptop bottom.

FIG. 9A is a side elevation of a portable computer of FIG. 8, with the support structure deployed.

FIG. 9B is an expanded partial view of the portable computer of FIG. 9A, with focus on the pocket used to house the support structure.

FIG. 10A is a side elevation of a portable computer, according to another embodiment, showing the support structure attached to the inside of the computer base.

FIG. 10B is an expanded partial view of the portable computer of FIG. 10A, with focus on the internally mounted support structure.

FIG. 11 is a side view of the portable computer of FIG. 10A, with support structure deployed.

FIG. 12 is a perspective view of the portable computer of FIG. 10A, showing deployed support beams.

FIG. 13 is a bottom view of the portable computer of FIG. 10A, with retracted support beams.

FIG. 14 is a bottom view of the portable computer of FIG. 10A, with deployed support beams.

FIG. 15 is a bottom view of the portable computer according to another embodiment, showing a retracted support plate.

FIG. 16 is a bottom view of the portable computer according to another embodiment of the invention, showing a deployed support plate.

FIG. 17A is a side elevation of the portable computer according to another embodiment, showing a side-mounted retracted support structure.

FIG. 17B is an expanded partial view of the embodiment of FIG. 17A, focusing on one of the lateral support beams.

FIG. 18 is a side elevation of the portable computer of FIG. 17, showing a deployed side-mounted support structure.

FIG. 19 is a rear perspective view of the portable computer according to another embodiment, showing a rear surface-mounted retracted support structure.

FIG. 20 is a rear perspective view of the portable computer of FIG. 19, showing a rear surface-mounted deployed support structure.

FIG. 21 is a side elevation of the portable computer of FIG. 19, showing a rear surface-mounted retracted support structure.

FIG. 22 is a side elevation of the portable computer of FIG. 19, showing a rear surface-mounted deployed support structure.

FIG. 23 is a side elevation of the portable computer according to another embodiment, showing a threaded support structure.

FIG. 24 is a perspective view of a portable computer according to another embodiment, having a reduced depth keyboard enabling a larger second display.

FIG. 25 is a top plan view of the keyboard in the embodiment of FIG. 24.

FIG. 26 is a perspective view of a portable computer according to another embodiment, having a reduced depth keyboard.

FIG. 27 shows a prior art key for a computer keyboard.

FIG. 28 shows a key for a computer keyboard according to an embodiment in which key caps include variable display elements.

FIG. 29 shows a portable computer according to another embodiment, with a support structure, a large second display and a virtual keyboard.

FIG. 30 shows a portable multiscreen computer according to another embodiment, with the second screen hinged on top of the first screen.

FIG. 31 is a side elevation of the portable computer of FIG. 30, with the two screens deployed, both facing the user.

FIG. 32 is a side elevation of the portable computer of FIG. 30 in presentation mode, with the two screens deployed and active, the main screen facing the user and the second screen facing an audience on the opposite side of the laptop.

FIG. 33 is a side elevation of the portable computer of FIG. 30, with the two screens turned off and being folded down to shut down the computer.

FIG. 34 is a side elevation of the portable computer of FIG. 30, with the second screen folded down onto the main screen, in order to shut down the laptop.

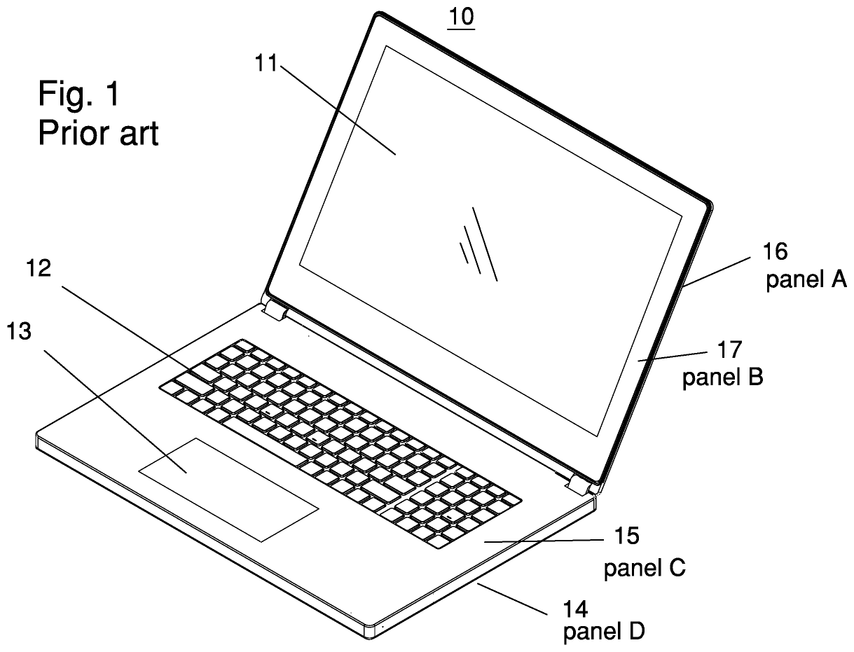

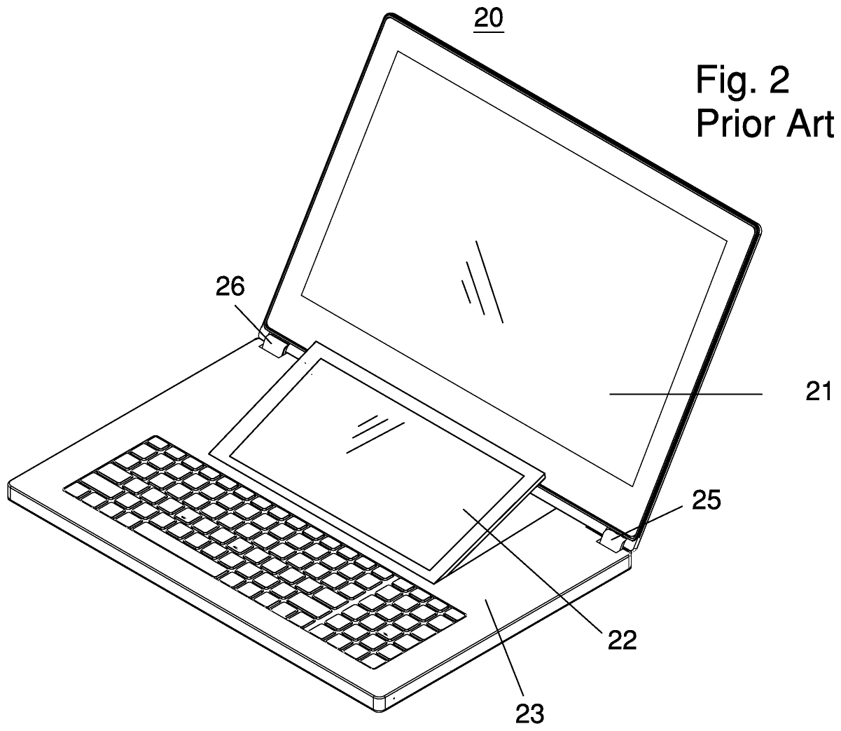

### DETAILED DESCRIPTION OF THE DRAWINGS

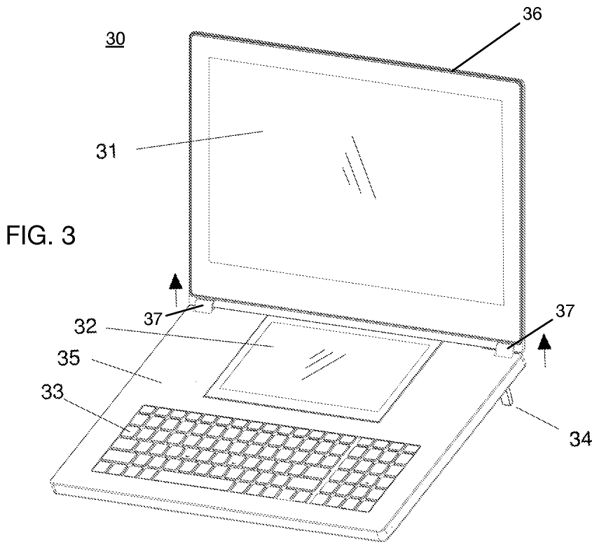

FIG. 3 shows a first embodiment of a laptop computer 30, which includes a main display panel 31 within a laptop computer display unit 36. Display unit 36 is attached to base unit 35 via a hinge structure comprising hinges 37, thereby forming a clamshell configuration whereby the front surface of display unit 36 may be folded down adjacent to the front surface of base unit 35. A second display panel 32 is fixedly mounted to the laptop base unit 35 within its front surface, such that the angle of second display panel 32 is not adjustable during operation relative to (and the top surface of display panel 32 is preferably parallel to) the front surface of base unit 35.

When the second display is installed in a fixed position in the base unit (as opposed to a movable, hinged second screen), there is no need to provide hinges and a surrounding structure around the second screen, such as a case, a front panel and extendable wires and cables to accommodate the rotation of the screen. The embedded, fixed position second screen is a simple and very reliable solution. However, the embedded fixed second screen has some major problems that may make it impractical if not properly addressed: the viewing angle for the user is unfavorable, and causes a lower, sub-optimal image quality, even if the LCD is designed to provide as wide a viewing angle as possible. Furthermore, the overhead lighting of the office or room are reflected on the screen, hindering readability and image discernibility. Embodiments described herein address some or all all those issues by providing a support structure attached to the laptop that tilts the laptop base to a desired angle, eliminating the above mentioned disadvantages and providing a proper viewing angle with excellent image quality. The deployment of the supporting structure by the user corrects the viewing angle for the second screen, but in doing so, it also distorts the viewing angle for the main display. However, since the main display has great adjustability via a hinge structure attaching the display unit to the base unit, the user can easily correct that issue by reaching for the main display and rotating it to the desired new optimal viewing angle. Such a laptop design allows the user to easily achieve the correct viewing angle for both screens, which is sometimes herein referred to as dual adjustability.

Thus, laptop computer 30 further includes keyboard 33, and a support structure 34. Support structure 34 can be used by a user to tilt the base unit 35 to a desired angle of inclination relative to a table top or other surface on which computer 30 rests. The support structure is only partly visible in FIG. 3, but will be shown and described in detail in subsequent figures. The embodiment of FIG. 3 does not include a touch pad; such a navigation device may not be necessary to the extent that second screen 32 is a touchscreen, as second screen 32 can serve as a large touchpad if needed. However, it is contemplated and understood that other embodiments may incorporate a touchpad and/or other type of pointing device, with minor variations. For example, in some embodiments, a narrower keyboard 33 could be incorporated, providing space for a touchpad on the base unit top surface to a side of the keyboard. In yet other embodiments, a pointing stick positioned within the keyboard key array may be provided to facilitate navigation of a computer user interface. In yet other embodiments, both main display 31 and second display 32 may be touch-sensitive displays, enabling a tap-based user interface and eliminating a need for a touchpad or other pointing device.

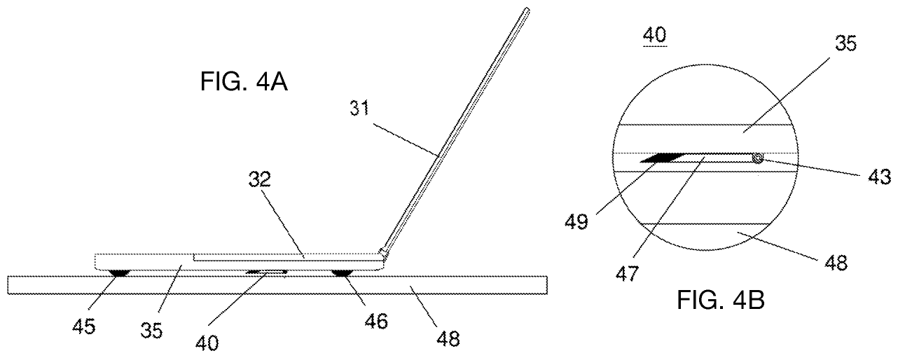

FIG. 4 is a side view cross-section of the first embodiment, showing a main screen 31, a second screen 32, a base 35, laptop feet 45 and 46, the surface of a table or desk 48, and the support structure 40. FIG. 4A is an expanded partial view of the embodiment of FIG. 4 further illustrating support structure 40, which includes a rotating deployable beam 47 mounted under the laptop base 35 and above the desk surface 48; a hinge 43; and a tip 49, which may be made of rubber, plastic or other anti-slip, non-scratching material.

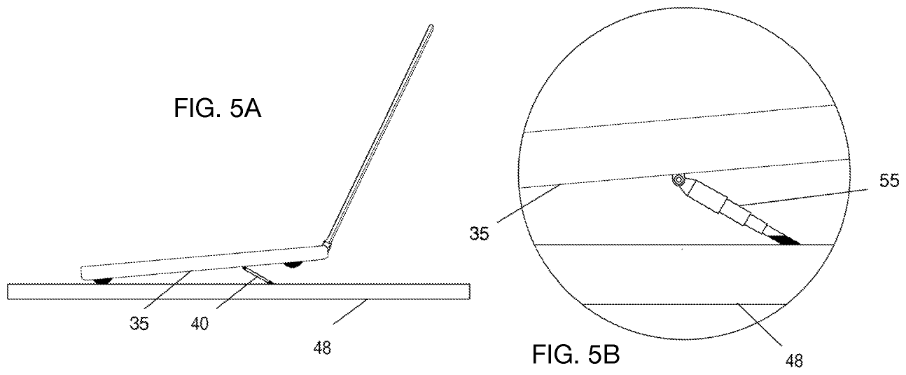

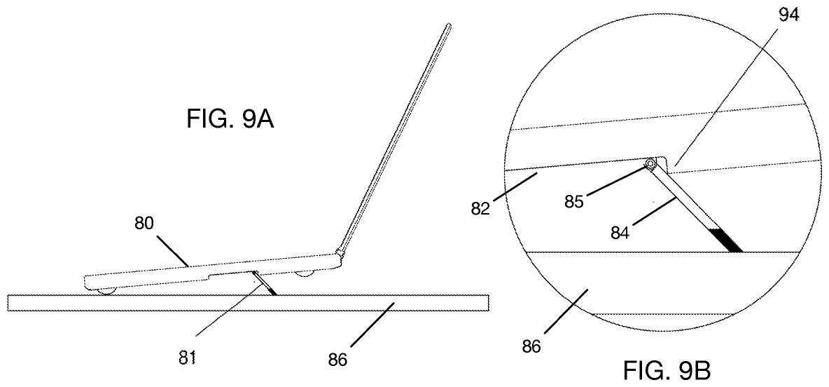

FIG. 5 shows the first embodiment with the support structure 40 in a deployed position. A first version of the support structure would be based on a simple hinge with a pin at the rotating axis and with a stop that limits how wide the beam of the support structure can open. Such a simple support structure would provide only two options to the user: deployed or non-deployed, and the laptop can be inclined or non-inclined, without intermediate adjustment. To deploy, the user would reach under the laptop and use the slanted surface of the beam tip to lift it off the bottom of the laptop, then rotate it forward as far as it can go, which would be up to the position of the stop, and then deposit the laptop on the desk surface, achieving thereby the pre-determined maximum incline angle. The stop controlling the support structure range of motion can be built into the hinge itself, by providing a tab or other protrusion attached to the hinge or concentric with it which stops the rotation upon contact, or alternatively it can be provided by the surrounding structure (see FIG. 9 for such an example). The position of the stop determines the maximum incline angle that such a support structure can provide to the user, along with the position of the hinge relative to the laptop base and the length of the beam. The further forward the hinge is located, the lower the maximum achievable incline angle. Similarly, the shorter the beam, the smaller the maximum incline angle.

Because the base unit contains a fixed-angle secondary display panel, it may be desirable to enable the laptop base to achieve a significant incline relative to a surface on which the laptop rests, thereby significantly reducing the viewing angle of the secondary display panel to improve image quality and possibly reduce the user's perception of reflections on the display panel surface. In some embodiments, in order to enable increased base incline for a given support structure length, it may be desirable to position the support structure beneath a middle portion of the base unit underside, rather than along a rear edge of the base unit. That said, preferably, the support structure will be positioned such that the laptop center of gravity remains sufficiently forward of the support structure to avoid the laptop inadvertently tipping backwards during use. For example, in the embodiment of FIG. 5, support structure 40 is hinged approximately 2/3 of the way from the front edge to the rear edge of the laptop base unit, with the support structure deployment angle causing the support structure to contact a flat surface on which the laptop rests approximately 75% of the way from the front edge to the rear edge of the laptop base unit.

Another more sophisticated version of the support structure 40 can be mounted to base 35 via a friction hinge, which could allow continuous adjustment of the incline angle of support structure 40. Yet another option is a support structure with multiple stops, which would provide a discrete number of incline angles. These and other options may provide beneficial adjustment of support structure positioning.

The support beam 40 shown in FIG. 5 is of a fixed length. However, in other embodiments, the support structure may incorporate an adjustable length, potentially providing another mechanism for adjusting the computer incline. FIG. 5A is an expanded view of such an embodiment, in which extendable support beam 55 is a telescoping beam, comprised of multiple segments at least partially retractable into adjacent segments, with beam 55 hingedly attached to a bottom side of base unit 35. By adjusting the telescoping length of beam 55, the incline of base 35 relative to surface 48 may be readily adjusted.

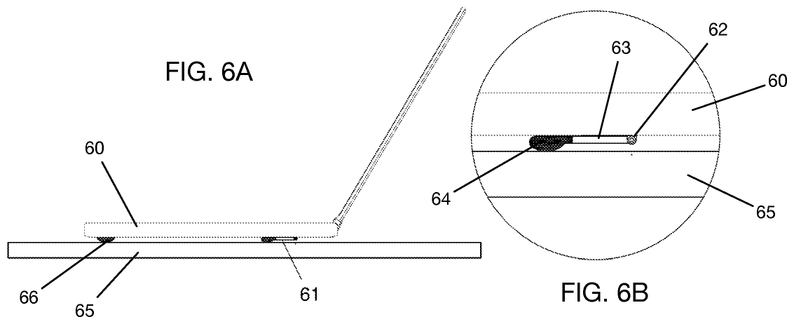

FIG. 6A shows another embodiment of the support structure, wherein the forward feet of the laptop computer 60 are integrated with a deployable support structure 61. FIG. 6B is an expanded partial view of the support structure with integrated feet. Deployable support structure 61 includes hinge 62, support beam 63 and foot 64. Hinge 62 rotatably connects to a proximal end of support beam 63, with a bottom side of the laptop computer 60. Foot 64 is connected with (or integrally formed from) a distal end of support beam 63, opposite hinge 62. Foot 64 is preferably formed from rubber or another material that inhibits sliding of foot 64 across support surface 65, and has a thickness (measured relative to the longitudinal axis of support beam 63) that is greater than the thickness of support beam 63, and offset relative to support beam 63. When support beam 63 is in a retracted position (e.g. flush against the laptop computer bottom surface), a portion of foot 64 extends below the support beam to make contact with a surface 65 on which the laptop computer rests, thereby enabling laptop computer 60 to rest securely on deployable forward feet 64 and fixed rear feet 66.

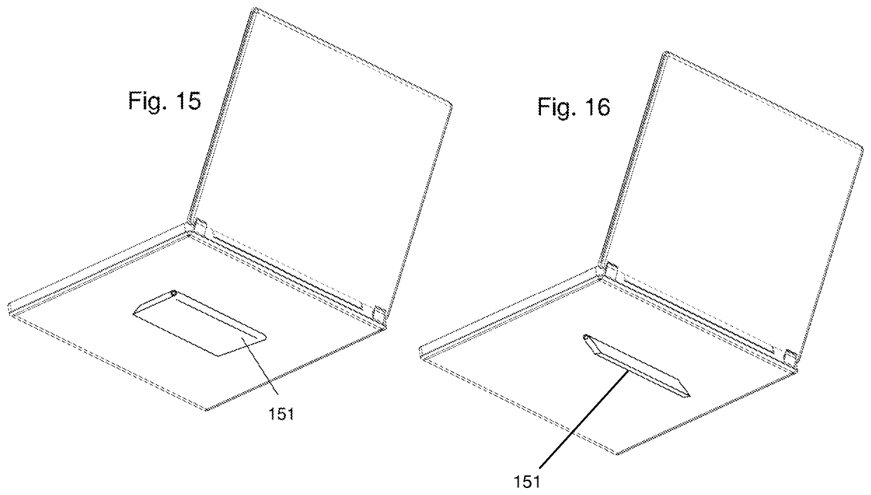

While FIGS. 6A and 6B reflect a view from the right side of laptop computer 60, it is contemplated and understood that in some embodiments, laptop computer 60 may include a conventional four-footed support configuration, such that two fixed rear feet 66 are positioned near rearward left and right corners of laptop computer 60, and two deployable forward feet 61 are positioned on left and right sides of laptop computer 60. Of course, in other embodiments, for example, deployable forward foot 61 could be formed having a width extending between the left and right sides of the laptop computer, (analogous to FIGS. 15 and 16), thereby enabling implementation with a single deployable support structure rather than separate left and right deployable support structures.

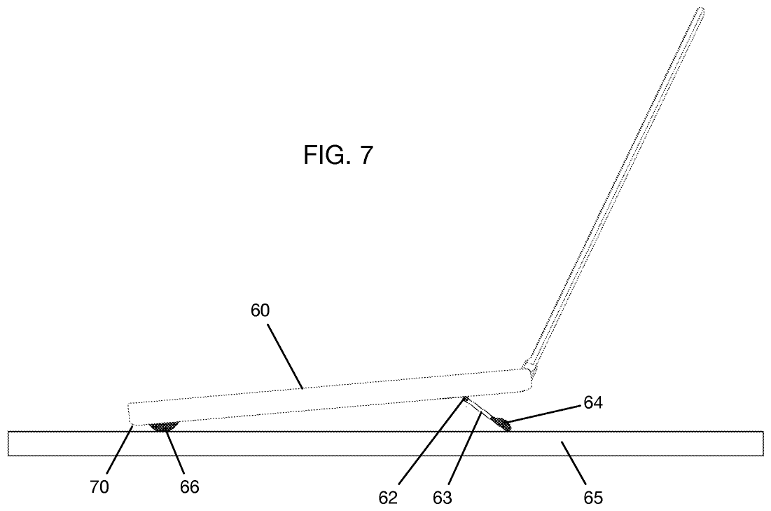

FIG. 7 shows the support structure with integrated feet in deployed position. Support beam 63 is pivoted around hinge 62 (e.g. via manual user manipulation) into a deployed position, in which deployable support structure 61 lifts laptop computer 60 into an inclined position relative to support surface 65. Foot 64 continues to provide a skid-inhibiting forward point of contact for laptop computer 60. Rear foot 66 continues to provide a skid-inhibiting rearward point of contact for laptop computer 60. Rear foot 66 preferably has sufficient thickness such that rear edge 70 of laptop computer 60 continues to clear surface 65, even when the rear edge of laptop computer 60 is cantilevered downwards at the maximum angle of incline for laptop computer 60.

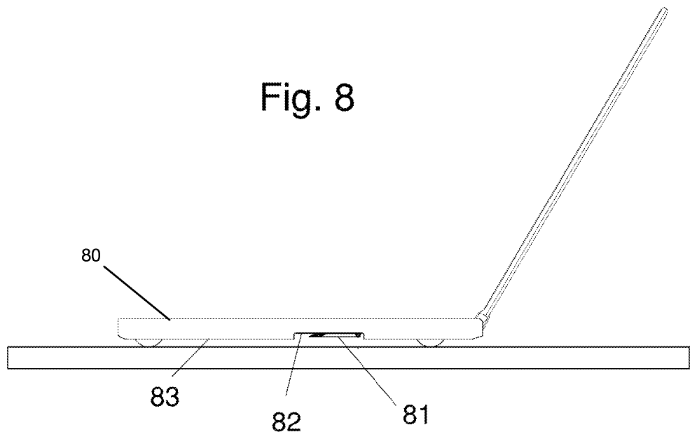

FIG. 8 shows a support structure 81 that, when retracted, may be recessed into a cavity 82 in the bottom of laptop computer 80 in order to avoid increasing the total or maximum thickness of the laptop computer. The embodiment of FIG. 8 also provides a relatively clean and continuous bottom surface for the laptop computer when support structure 81 is in a retracted position (illustrated in FIG. 8), improving aesthetics and reducing opportunities for accidental damage to support structure 81. To that effect, the D-panel 83 has an area that is bent upward to form cavity 82 and house support structure 81.

FIG. 9A shows the embedded support structure 81 in deployed position. Support beam 84 is pivoted around hinge 85 (e.g. via manual user manipulation) into a deployed position, in which support structure 81 lifts laptop computer 80 into an inclined position relative to support surface 86. FIG. 9B is an expanded view of FIG. 9A, showing as an example how the maximum incline angle of the laptop can be predetermined by allowing support beam 84 to rotate only until it makes contact with the D-panel at corner 94.

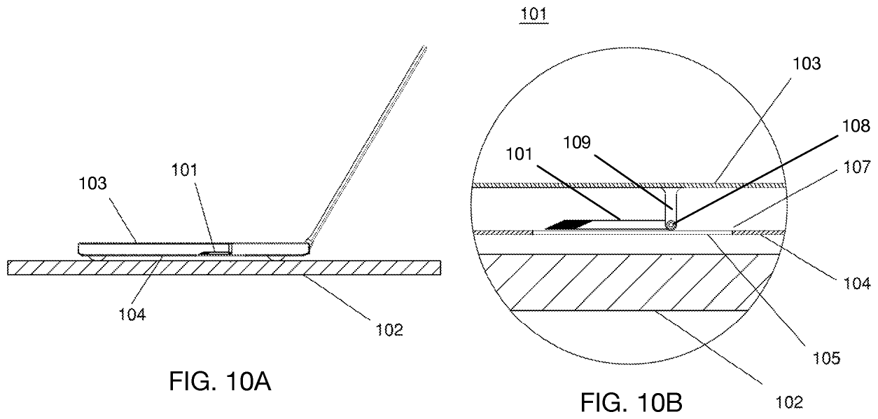

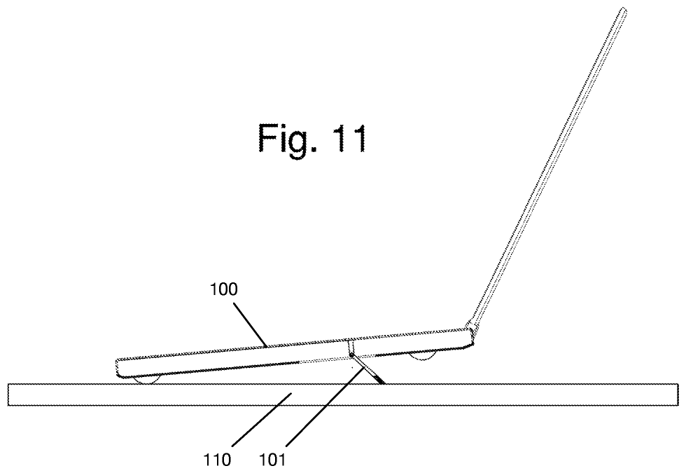

FIG. 10A shows another embodiment of a laptop computer having a deployable support structure, wherein the support structure is attached to the inside surface of the C-panel 103. FIG. 10B is an expanded partial cutaway view of the support structure of FIG. 10A, showing the support structure hinged to the C-panel 103. In particular, appropriate apertures 105 in the D-panel 104 allow a support beam 101 to deploy from inside the laptop body by rotating about a hinge 108. Hinge 108 may be mounted to C-panel 103 via flange 109. In some embodiments, the end 107 of aperture 105 on the D-panel 104 can be used as a stop, wherein support beam 101 may be rotated about hinge 108 until the support beam contacts end 107, thereby pre-determining the maximum angle of rotation of the support beam 101. In other embodiments, other mechanisms for determining a maximum angle of rotation for support beam 101 may additionally or alternatively be employed, such as, without limitation, a hinge mechanism having a maximum angle of rotation; or a support stop integrated into flange 109. FIG. 11 shows the internal support structure of FIG. 10 in deployed position, such that support beam 101 supports laptop computer 100 in an inclined position relative to surface 110.

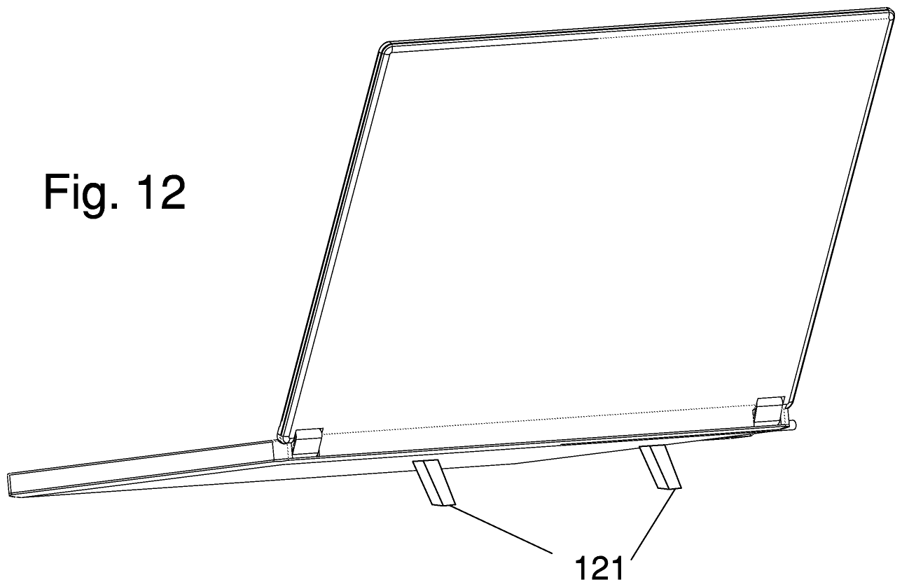

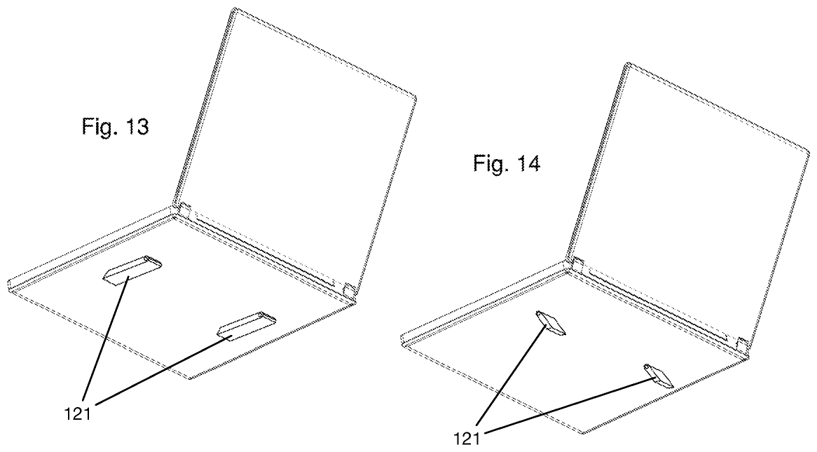

As mentioned above, various embodiments illustrated in side view in the foregoing Figures may employ varying numbers of the illustrated support mechanisms. For example, FIG. 12 shows a perspective view of an embodiment with a support structure 121, which consists of two support beams shown in a deployed position: one positioned on a left side of the laptop computer, and one positioned on a right side thereof. FIG. 13 is a bottom perspective view of the embodiment of FIG. 12, showing the support beams 121 retracted under the laptop when not in use. FIG. 14 is another bottom view with the support beams 121 in deployed position.

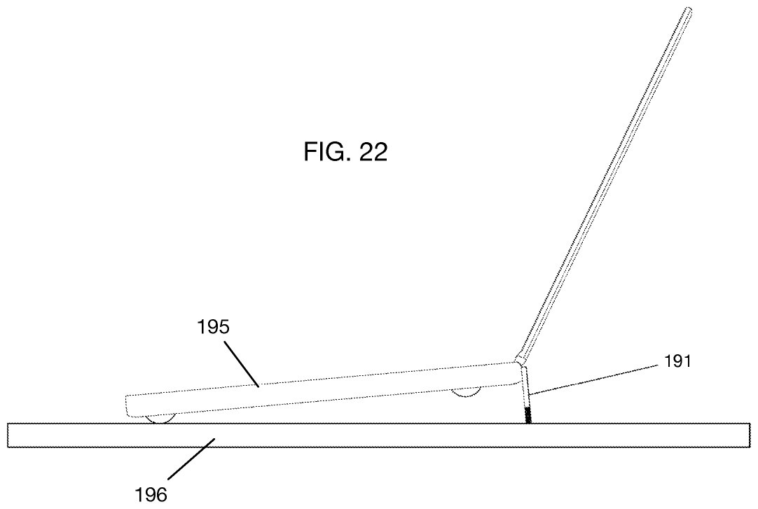

FIG. 15 shows that the support structure in some embodiments may be formed from a single continuous articulated plate 151, rather than multiple individual support beams. Articulated plate 151 includes a hinge attached to the laptop computer about which the plate may rotate. In the embodiment of FIGS. 15-16, articulated plate 151 is attached to the bottom plate of the laptop computer via a transverse hinge oriented in parallel with the front and rear edges of the laptop (i.e. from right to left). In some embodiments, such as articulated plate may additionally or alternatively recess into a cavity formed in the bottom side of the laptop computer (analogous to FIGS. 8, 9A and 9B), recess through an aperture in the laptop computer D-plate (analogous to FIGS. 10A, 10B and 11), and/or be secured to another portion of the laptop computer (such as the C-plate via a flange, analogous to the embodiment of FIGS. 10A, 10B and 22). FIG. 15 illustrates articulated plate 151 in retracted, non-deployed position. Articulated plate 151 can be hinged about, for example, a pin, a friction hinge, or a friction hinge with one or more stops. The stops can also be provided by the surrounding structure, as previously shown in FIG. 9. FIG. 16 shows the articulated plate 151 support structure in deployed position.

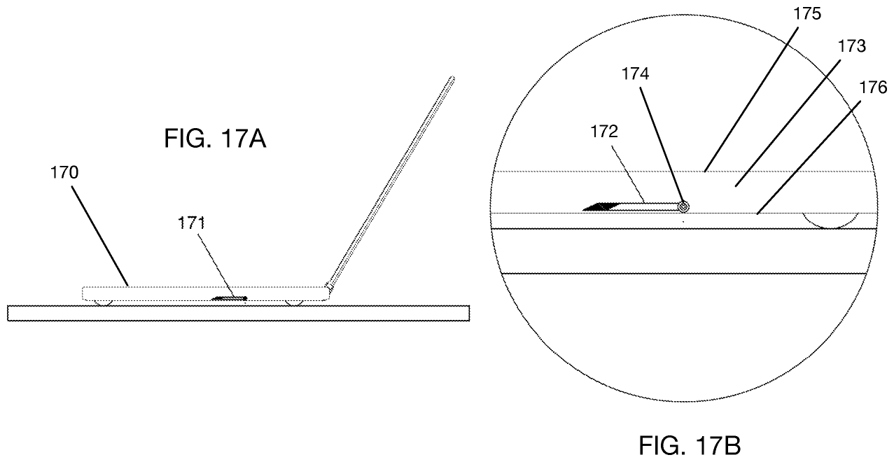

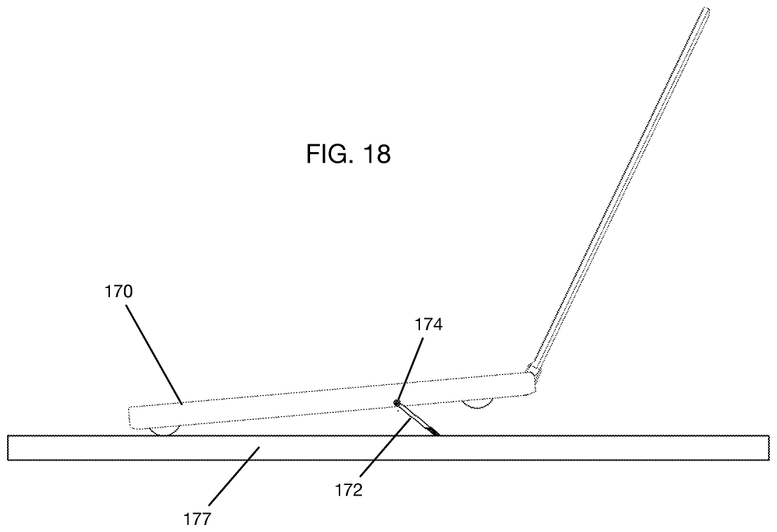

FIG. 17A shows a side view of a different embodiment, where the support structure consists of deployable lateral beams or tabs 171 which are attached, hinged, pivoted or linearly guided on the left and right side surfaces of the laptop computer 170. This arrangement allows a reduction of the thickness of the multiscreen laptop because there is no structure requiring space under the bottom of the laptop or inside the laptop to accommodate base-internal hinges. FIG. 17B is an expanded, partial view of FIG. 17A, with side support beam 172 rotatably attached to right side surface 173 via hinge 174, with hinge 174 oriented transversely to provide a plane of rotation for support beam 172 that is parallel to right side surface 173 and perpendicular to the plane of the laptop computer C-panel 175 and D-panel 176. FIG. 18 shows the multiscreen laptop of FIG. 17A with side support structures 171 in deployed position, holding a base portion of laptop computer 170 in an inclined position relative to support surface 177. For deployment, the lateral beams 172 can be rotated into a desired angle if they are attached to the laptop sides, or they can be linearly pushed into the right position if they are attached with linear guides to the laptop sides.

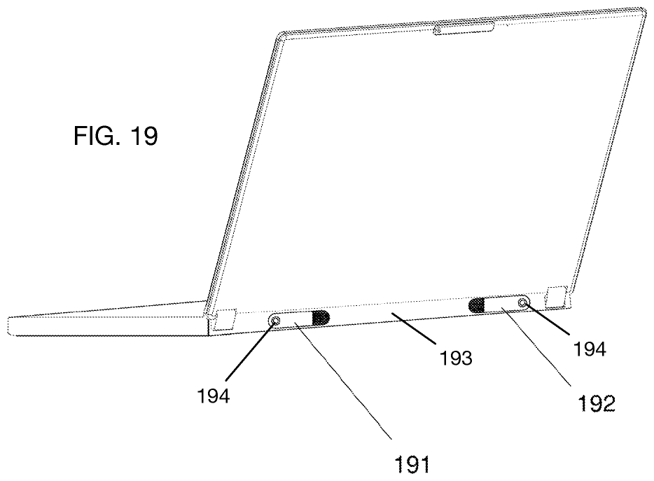

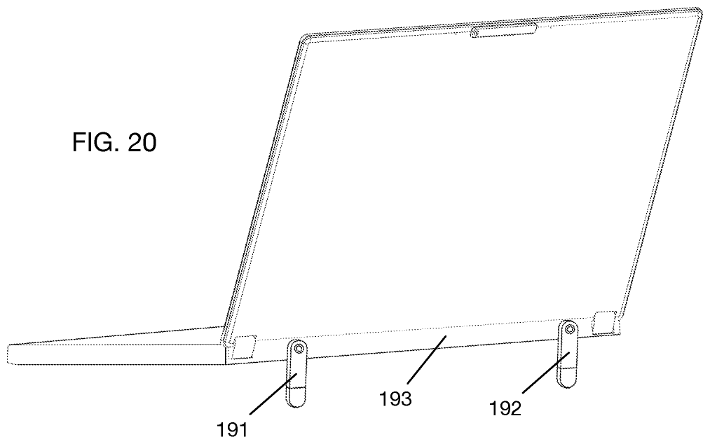

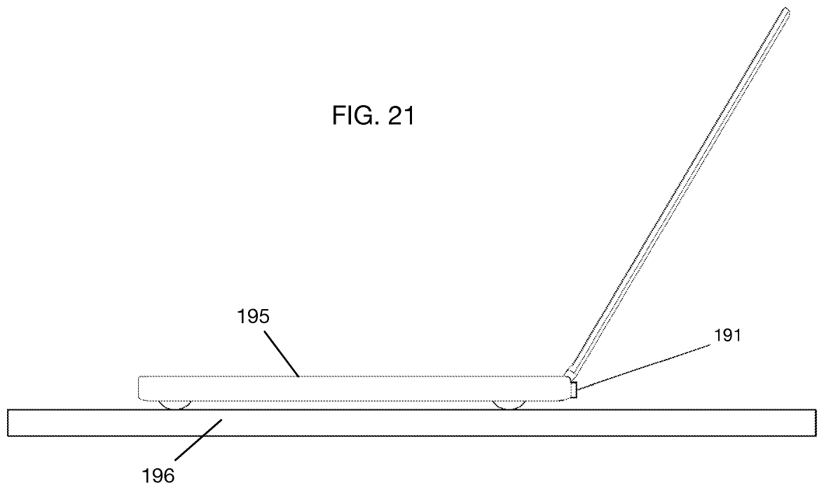

FIG. 19 shows a support structure based on pivoted tilting tabs or beams 191 and 192 attached to the rear surface 193 of the laptop computer base unit, in a retracted position. Beams 191 and 192 are each attached via a hinge 194 having an axis perpendicular to rear surface 193, such that beams 191 and 192 can rotate within a plane parallel with rear surface 193. Alternatively a wider single tab near the center of the rear surface 193 can be used. FIG. 20 shows the tilting tabs 191 and 192 each in deployed position. FIG. 21 is a side view of the multiscreen computer of FIG. 19 with the tilting tabs 191 and 192 in retracted, non-deployed position. FIG. 22 shows a side view of FIG. 19 with the tilting tabs 191 and 192 in deployed position to adjust the viewing angle of the multiscreen laptop base unit display by inclining base unit 195 relative to support surface 196.

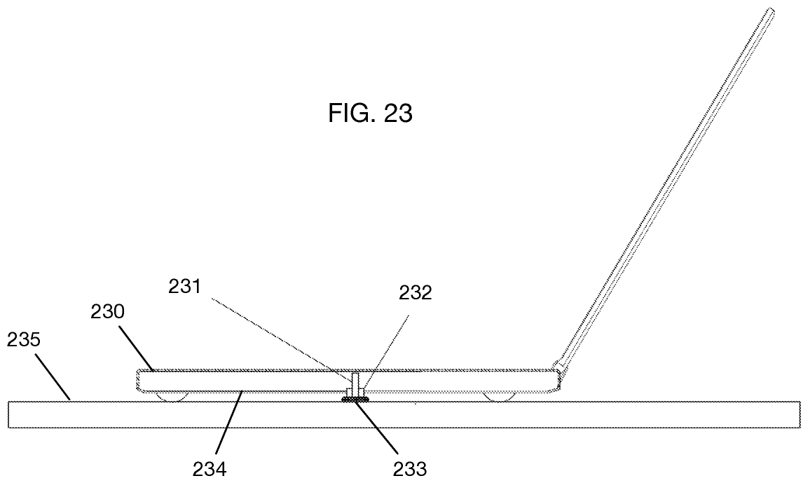

FIG. 23 shows a laptop 230 having a support structure having a threaded support element that may be rotated to vary its state of deployment. In particular, laptop 230 includes on feet with threaded shafts that can be retracted by screwing the threaded shaft into the laptop, or deployed by unscrewing the threaded shaft from the laptop. In particular, laptop 230 includes threaded shaft 231 fixedly attached to rubber foot 233. Nut 232 is secured to laptop D-panel 234, and sized such that shaft 231 may be threaded into nut 232. In operation, foot 233 (and therefore shaft 231) can be rotated clockwise (assuming normal threading of shaft 231 and nut 232) to retract foot 233 inwards towards D-panel 234 and lower the angle of inclination for laptop 230 relative to support surface 235. Likewise, foot 233 (and therefore shaft 231) can be rotated counterclockwise to deploy foot 233 outwards from D-panel 234, thereby increasing the angle at which laptop 230 rests on support surface 235. By deploying or retracting foot 233 to set the support structure to a desired length, a user may impart a desired angle to the multiscreen laptop.

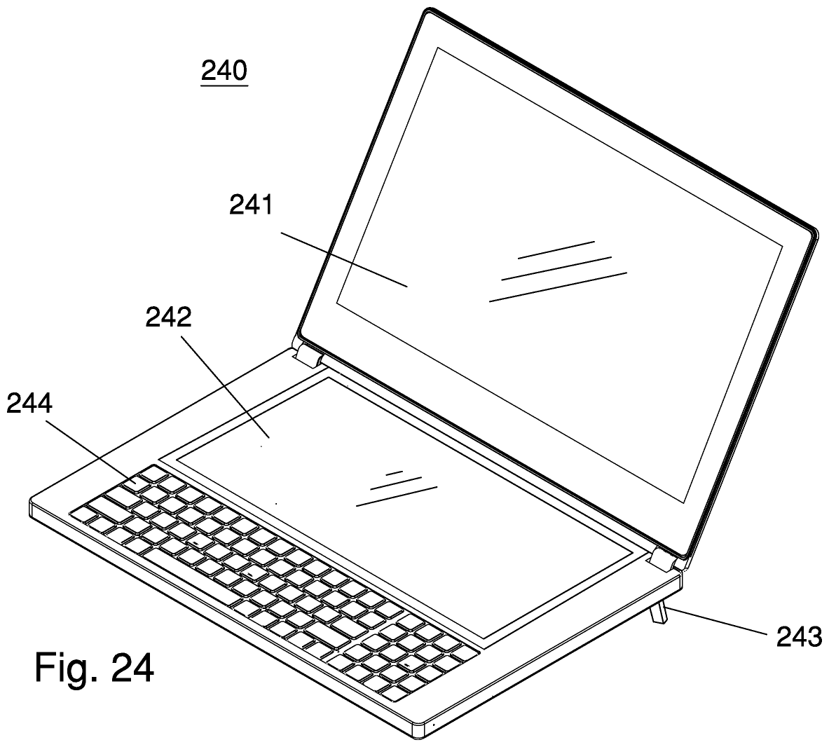

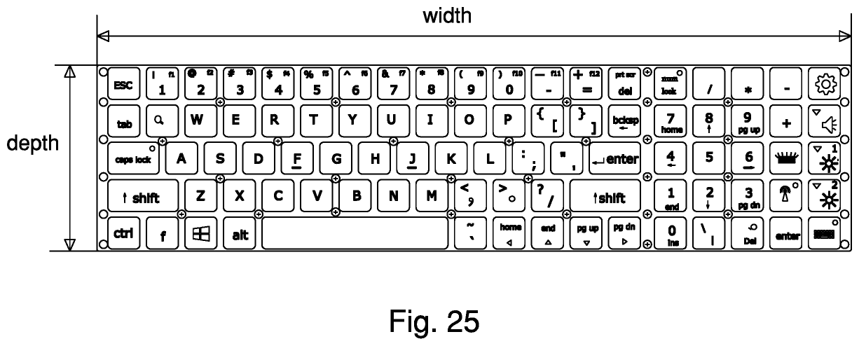

FIG. 24 shows a different embodiment. The multiscreen laptop 240 includes a main screen 241, a second screen 242 which is fixedly embedded in the laptop base, a support structure 243 that allows tilting of the laptop to adjust the viewing angle of the second screen and a reduced size keyboard 244 that makes it possible to use a relatively large second screen 242. The reduced depth of the keyboard can be achieved by using a reduced number of key rows; for example, in a conventional PC using Windows or Unix-based operating systems, only 5 rows of keys may be provided as opposed to the customary and standard 6 rows of keys. While certain Apple Macbook Pro computers utilize five rows of hard keys, supplemented by a sixth row of soft keys implemented on a Touch Bar display, it may be desirable in embodiments described herein to limit the total depth of hard and soft keys to five rows, or in some embodiments four or fewer rows, thereby leaving a greater portion of the base unit top surface available for a second display used for purposes other than soft-keys. This reduction in the number of rows is possible by assigning multiple functions to certain keys. An example of that is shown in FIG. 25. Through multi-label assignment to keys it is possible to reduce the number of key rows, without necessarily reducing the pitch between keys and the size of the keys, since it is highly desirable to respect customary pitch and keycap size in order not to confuse users familiar with current keyboard layout and sizes, and allow them to continue touch typing (typing without looking) as many are used to doing.

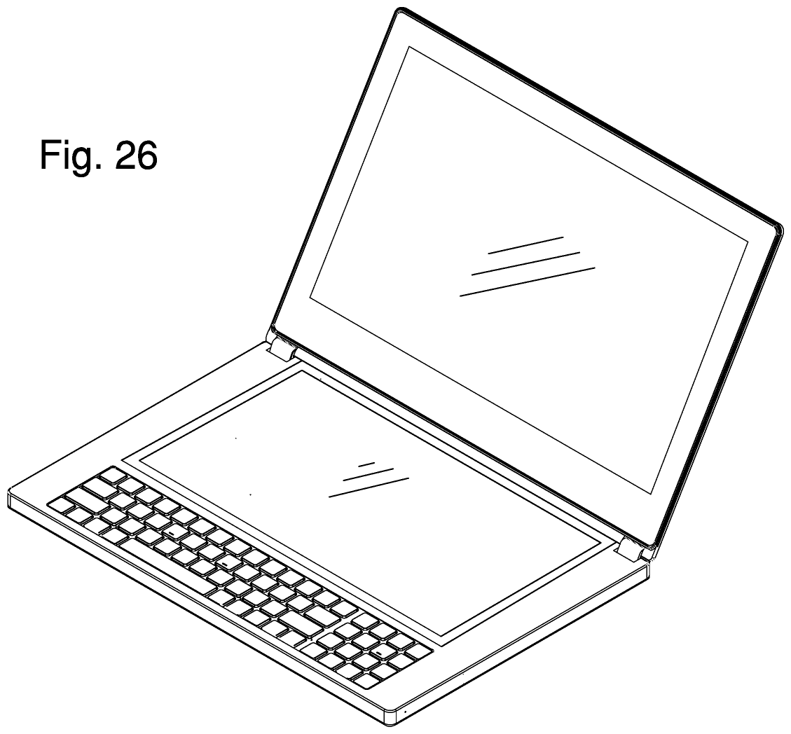

FIG. 26 shows another embodiment with a keyboard with only 4 key rows, and with an even larger second screen. This becomes also possible through multi-label assignment to keys.

Other embodiments are also possible by dropping the requirement to use customary keycap sizes and pitches (e.g. reducing the surface area of keyboard key caps as compared to conventional keyboard designs), because this requirement is not critical for every user. Some users, such as users who do not touch type or users with smaller hands, may accept or prefer a smaller keyboard with smaller keys and with a small number of rows.

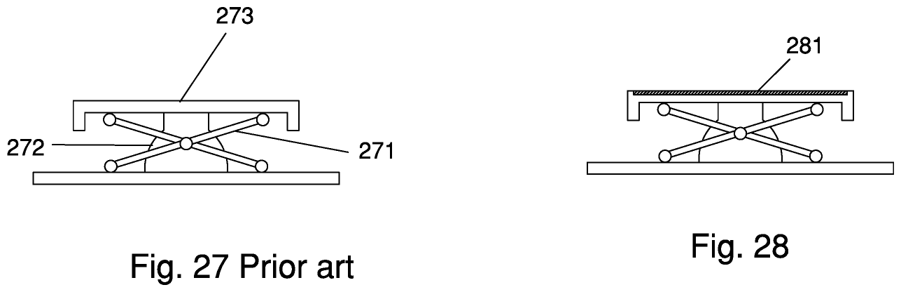

Another way to make the keyboard smaller and more efficient, in order to be able to reduce its size and enable a larger second screen on the multiscreen laptop is described in FIGS. 27 and 28. FIG. 27 shows a prior art typical laptop key, with a scissor mechanism 271, a deformable rubber dome 272 and a keycap 273. FIG. 28 shows a keycap equipped with a top layer 281, which can display an electronic label, such as a miniaturized LCD (micro-LCD), a small OLED display or a small e-ink (electronic ink) display, making the keys adjustable and variable, which vastly reduces the number of keys required and makes it possible to use fewer keys and a substantially smaller keyboard, thereby enabling a larger second screen in the multiscreen laptop base unit.

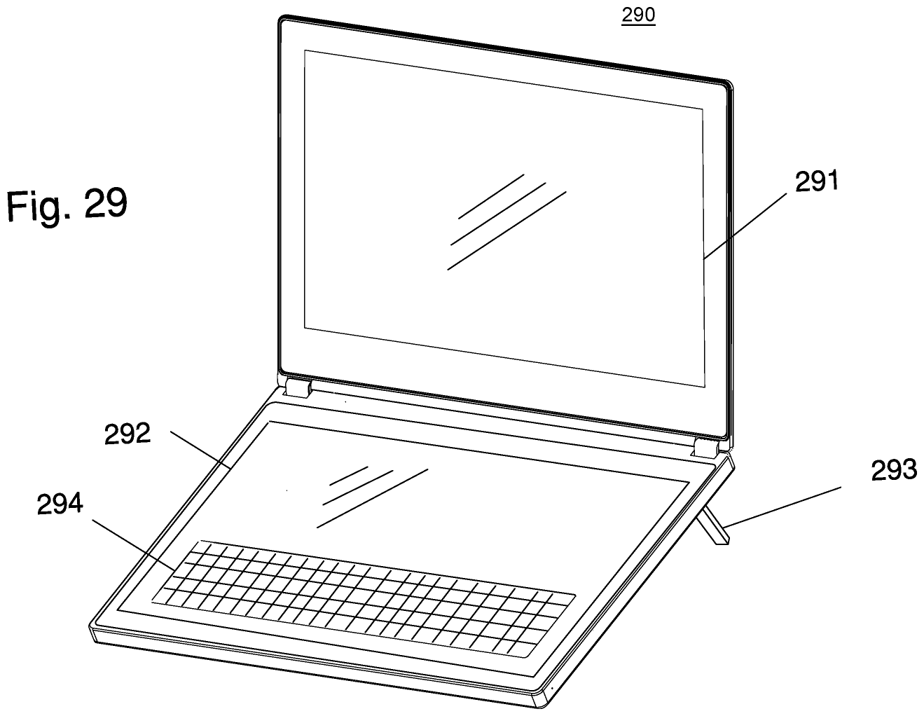

FIG. 29 shows another embodiment, in which the base unit display consumes a majority of the base unit top surface (i.e. a significant majority of the C-panel, such that the C-panel may consist primarily of a touch-sensitive display panel with surrounding bezel). For example, laptop 290 includes a main screen 291; a support structure 293; a very large secondary screen 292, which occupies virtually all the top area of the computer base and which can be basically the same or similar size as the main screen; and a virtual keyboard 294, which is the image of a keyboard displayed on the second screen, which is a touchscreen that the user can use to operate the virtual keyboard. The support mechanism 293 is a key component of this embodiment, because the image quality of the large second screen 292 would not be adequate if the second screen could not be oriented according to the viewing angle needed by the user. A continuously variable support mechanism with a friction hinge would enable perfect adjustment of the viewing angle for both screens, resulting in excellent image quality and high productivity on both large screens.

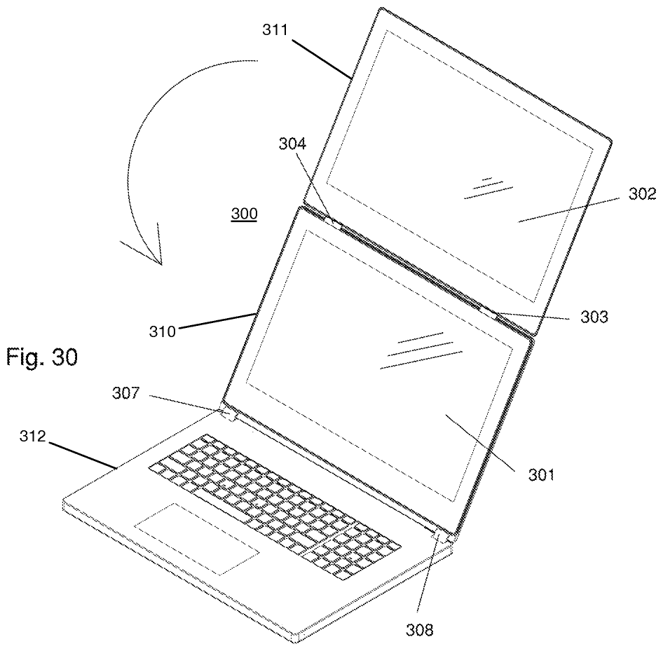

FIG. 30 shows another embodiment of a multiscreen laptop 300, wherein the display unit comprises two sections, attached to one another via a hinge structure, such that the sections may be opened to expose two display panels, or closed to fold the laptop for storage in a typical clamshell manner. In particular, when in an open configuration, second display unit section 311 (containing display panel 302) is located above the first display unit section 310 (containing display panel 301). The display unit sections 310 and 311 are attached to one another along an upper edge of section 310, and a lower edge of section 311, via a hinge structure that includes left hinge 304 and right hinge 303. During operation, hinges 303 and 304 allow a user to independently configure an angle of inclination for each of display panels 301 and 302, relative to a user of the computer. When computer 300 is not in use, a user may use hinges 303 and 304 to fold down second section 311 onto first section 310, in the direction shown by the arrow, such that the computer can then be closed in a conventional and space-efficient clamshell arrangement by folding the display unit onto base unit 312 via a hinge structure that includes hinges 307 and 308. In various embodiments, the two display panels 301 and 302 can be equal in size, similar in size or even totally different, depending on the needs of the user.

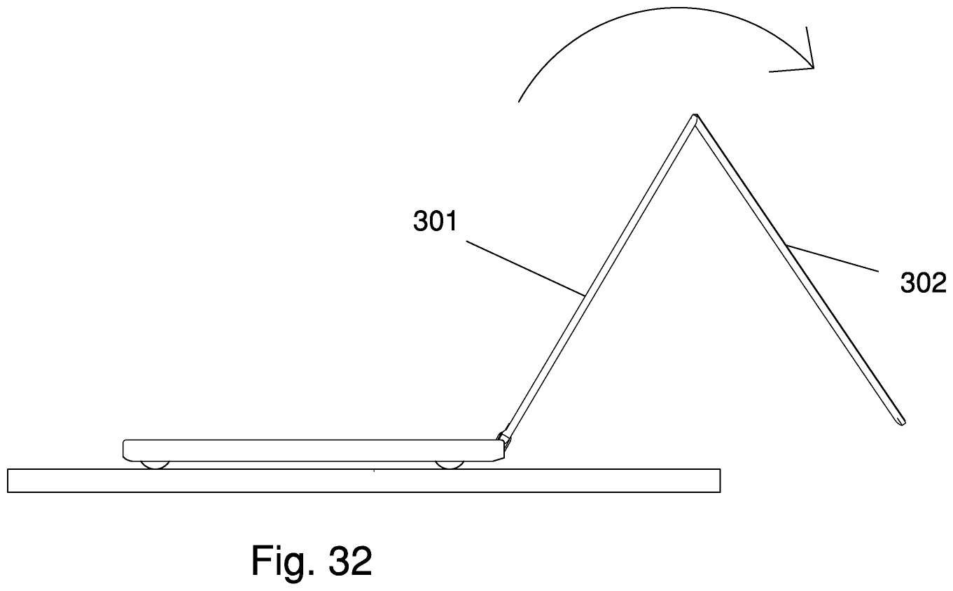

The display unit hinges 303 and 304 should preferably be a friction hinge of the wide angle type, as commonly used in 2-in-one laptops, which allow a rotation of about 360 degrees. That makes it possible for the laptop of FIG. 30 to fold the two screens in many convenient and productive ways, including the presentation mode explained in FIG. 32. That also has the advantage that both screens are protected when the laptop is closed. The main assembly hinges 307 and 308 may require a higher torque rating than ordinary conventional laptops because of the added weight they will carry and/or increased leverage from the increased total height of stacked displays 301 and 302. It is also possible to use a larger number of hinges on the main display to provide extra torque capacity.

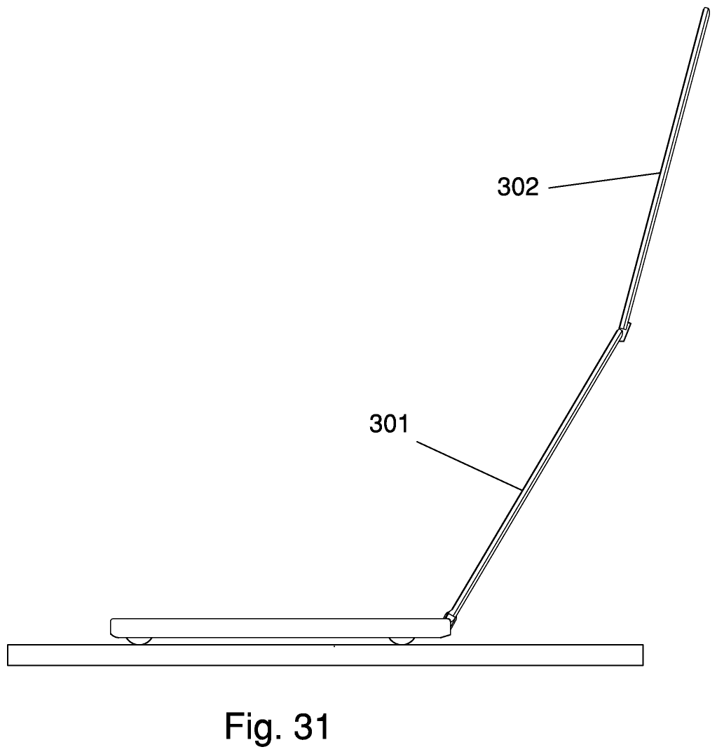

FIG. 31 shows a side view of the laptop of FIG. 30 with both display panels 301 and 302 turned on, deployed and facing the user.

FIG. 32 shows the laptop of FIG. 30 in presentation mode, which is achieved by rotating the second display panel 302 toward the rear of the laptop (as shown by the arrow in FIG. 32), so that display panel 302 faces an audience on the opposite side of the laptop from the primary user, who views display panel 301.

In some embodiments, it may be desirable to include a position sensor within the display unit, to provide an input to the laptop computer operating system indicative of the relative position of second section 311 and thus second display panel 302. The laptop computer operating system may then be configured to automatically adjust the operation of display panels 301 and 302, based upon whether, e.g., laptop computer 300 is being used in a single-user/dual-display configuration (such as that of FIG. 31) or in a presentation mode (such as that of FIG. 32). Examples of automated adjustments of display panel operation may include, for example: rotating the image on secondary display panel 302 when oriented in a presentation mode, such that the display image appears “right side up” for the opposing viewer; and/or transitioning between a “desktop mirror” multi display mode of operation (in which the content of panel 301 is mirrored on panel 302), and an “extended desktop” mode of operation (in which the operating system generates an extended desktop display that spans panels 301 and 302). Such display position sensing may be achieved by any of a variety of mechanisms, such as: an orientation sensor embedded within second display section 311; or hinge position sensors within at least one of hinges 303 and 304, and optionally also at least one of hinges 307 and 308.

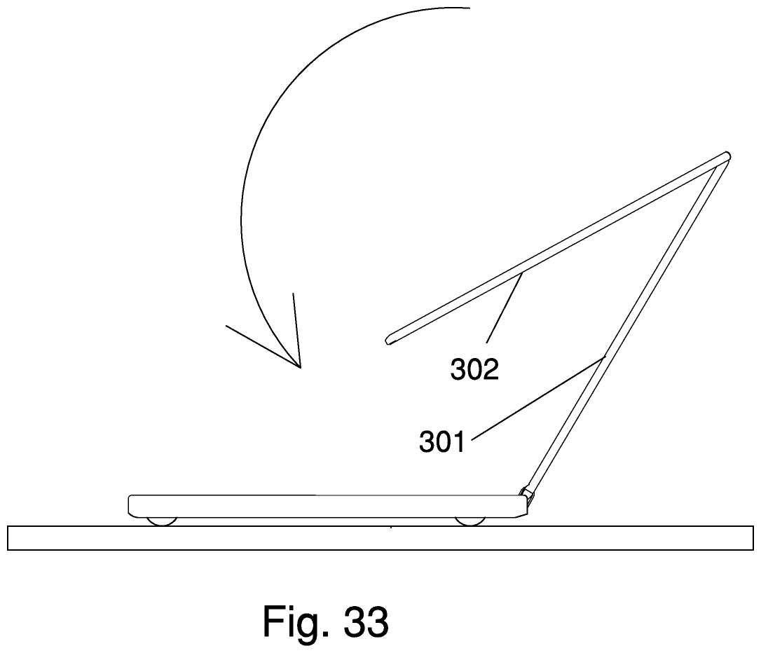

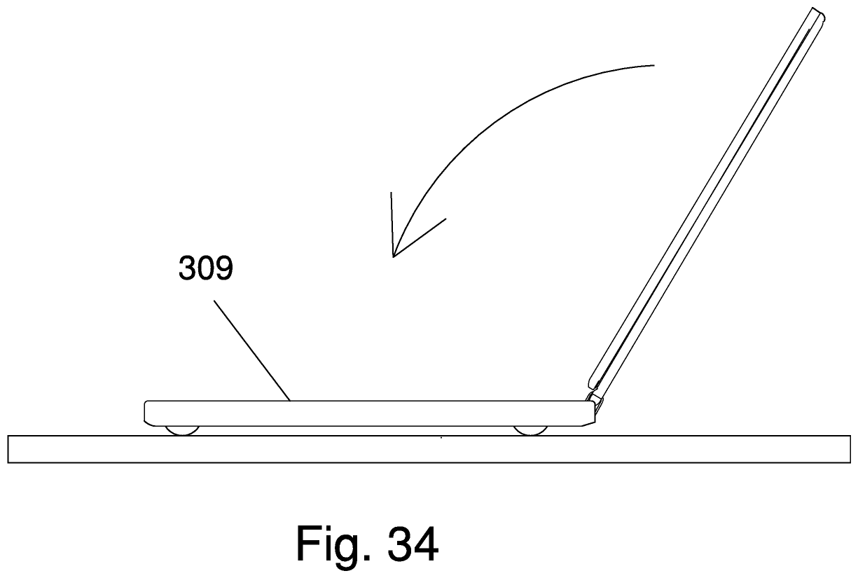

FIGS. 33-34 illustrate how to shut down and close the laptop. FIG. 33 shows that after turning off the laptop, the user can fold down the second screen 302 onto the first screen 301, as shown by the arrow, to achieve the orientation of FIG. 34. FIG. 34 shows that the two screens are now folded together and parallel to each other. The next step is to fold down both screens together onto the laptop base C-panel 309. In this position both screens are safely stowed away inside the clamshell.

The above disclosures and descriptions are exemplary in nature, and not intended to limit the scope of the invention. A person skilled in the art given the present disclosures could easily design variations and additional embodiments of the same invention based on these disclosures, which are all covered by the present application for letters patent.

What is claimed:

1. A portable computer system comprising:
a base unit;
a display unit attached to the base unit along a first edge via a first display unit hinge structure in a clamshell configuration, whereby a front surface of the base unit and a front surface of the display unit can fold adjacent to one another;
wherein the display unit has a front side with a first display panel mounted therein, whereby the viewing angle of the first display panel relative to a user of the portable computer system may be adjusted by operation of the first display unit hinge structure;
a second display panel mounted within said front surface of the base unit, the second display panel having a front surface mounted in a fixed, substantially parallel orientation with respect to the front surface of the base unit; and
a support structure attached to the base unit, the support structure movable between a deployed position and a retracted position to adjust a viewing angle of the second screen relative to the user of the portable computer by tilting the base unit with respect to a support surface on which the base unit may rest.

2. The portable computer system of claim 1, wherein the support structure comprises one or more support beams, attached to a bottom side of the laptop base unit by one or more support structure hinges.

3. The portable computer system of claim 2, in which the one or more support structure hinges are positioned on the bottom side of the laptop base approximately two-thirds of the distance between the front edge and the rear edge of the laptop base unit.

4. The portable computer system of claim 3, further comprising at least two fixed feet attached to the bottom side of the laptop base proximate a front edge thereof.

5. The portable computer system of claim 2, wherein the one or more support beams are telescopically extendable.

6. The portable computer system of claim 1, wherein the support structure comprises one or more support beams, the laptop further comprising a linear guide associated with each of the one or more support beams, into which each support beam may be linearly extended or retracted.

7. The portable computer system of claim 2, in which:
the support structure further comprises a deployable foot attached or integrally formed proximate a distal end of each support beam, each deployable foot extending below the support beam with which it is attached or integrally formed when said support beam is in a retracted position;
the portable computer further comprising one or more fixed feet attached to the bottom side of the portable computer proximate a front edge thereof;
whereby the portable computer, when the support structure is in a retracted position, may be supported on a flat support surface by said fixed feet and said deployable feet.

8. The portable computer system of claim 1, further comprising a cavity formed within a bottom surface of the base unit, into which cavity the support structure is contained when in a retracted position.

9. The portable computer system of claim 1, wherein the support structure is attached to the inside of the base unit and can deploy out of the base unit through appropriate openings in a bottom surface of the base unit.

10. The portable computer system of claim 1, wherein the support structure comprises a plurality of deployable beams.

11. The portable computer system of claim 1, wherein the support structure comprises a single deployable plate.

12. The portable computer system of claim 1, wherein the support structure is adjustable between a retracted position and a single deployed position.

13. The portable computer system of claim 1, wherein the support structure is deployable into a plurality of deployed positions.

14. The portable computer of claim 13, wherein the support structure may be continuously adjustable over deployed positions.

15. The portable computer system of claim 1, wherein the support structure comprises a friction hinge, whereby an incline angle of the base unit relative to a support surface on which the portable computer system rests can be manually adjusted by pushing the support structure against the resistance of the friction hinge to a desired position.

16. The portable computer system of claim 1, wherein said support structure comprises a left support attached to a left side of the base unit, and a right support attached to a right side of the base unit.

17. The portable computer system of claim 1, wherein the support structure is attached to a rear surface of the base unit.

18. The portable computer system of claim 1, wherein the support structure comprises a threaded element, which can be rotated by the user to vary a deployed position of the support structure and an incline angle of the base unit.

19. The portable computer system of claim 1, wherein the support structure comprises one or more threaded support elements, each comprising:
a threaded nut secured within a bottom surface of the base unit;
a support foot; and
a threaded shaft attached at a distal end to the support foot, the threaded shaft engaged with the threaded nut and rotatable to adjust a deployment position of the support foot, thereby adjusting an angle of incline of the base unit relative to a support surface on which the base unit may be positioned.

20. The portable computer system of claim 1, wherein the second display panel is a touchscreen that occupies a majority of the front surface of the base unit;
the portable computer system further comprising a virtual keyboard electronically displayed on the second display panel;
whereby a viewer's perception of image quality of the second screen can be improved by adjusting the position of the support structure.

21. The portable computer system of claim 1, further comprising:
a keyboard mounted within the front surface of the base unit, the keyboard having a reduced depth characterized by one or more of: the keyboard comprises keys arranged in five or fewer rows, including soft keys; the keyboard comprises keys having a reduced surface area than customary laptop computer key sizes; the keyboard comprises keys having key caps with a key cap top layer comprising an electronic display for variable display of key cap function;
whereby the surface area on the front surface of the base unit saved via use of the reduced depth keyboard is used to accommodate a larger second display screen.

22. A portable computer system comprising:
a base unit;
a display unit comprising a first section and a second section;
the display unit first section comprising a first display panel, the first section attached to the base unit along a first edge via a first hinge structure at a lower edge thereof;
the display unit second section comprising a second display panel, a lower edge of the second section attached to an upper edge of the display unit first section via a second hinge structure;
wherein the display unit and base unit can be closed in a clamshell configuration, whereby a front surface of the display unit second section may be folded against a front surface of the display unit first section, a back surface of the display unit second section then foldable against a front surface of the base unit.

23. The portable computer system of claim 22, in which the second hinge structure comprises extended range hinges, enabling said portable computer to be variably configured for operation as a dual screen computer, with both screens facing a user, or alternatively in a presentation mode, with the first display panel facing the user and the second display panel facing an audience in the opposite direction.
